(19) United States
(12) Patent Application Publication
(10) Pub. No.: US 2012/0160074 A1
(43) Pub. Date: Jun. 28, 2012

(54) CUTTING PLATFORM FOR CUTTING AND SHAPING A CLAY SLAB

(76) Inventor: David Lee, Surrey (CA)

(21) Appl. No.: 13/271,999

(22) Filed: Oct. 12, 2011

Related U.S. Application Data
(60) Provisional application No. 61/427,477, filed on Dec. 28, 2010.

(51) Int. Cl. B26D 7/01; B25B 11/00

(52) U.S. Cl. 83/522.11; 269/307

(57) ABSTRACT

The present invention relates to a cutting platform for cutting and shaping a clay slab. The platform has a water-absorbing cutting mat with a top surface for receiving the clay slab. The platform has a bottom surface opposite the top surface. The bottom surface is adapted to overlay a board. The platform includes grid-pattern indicia extending across the top surface of the mat. The grid-pattern indicia includes a first set of spaced-apart lines in parallel with each other and a second set of spaced-apart lines in parallel with each other. The first set of lines intersect with and are perpendicular to the second set of apart lines. The grid-pattern indicia includes unit measurement indicia. Cutting of the clay slab to a desired shape is facilitated by the cutting platform thereby.

### CROSS REFERENCE TO RELATED APPLICATION

This application claims the benefit of provisional application No. 61/427,477 filed in the United States Patent and Trademark Office on Dec. 28, 2010, the disclosure of which is incorporated herein by reference and priority to which is claimed.

### FIELD OF THE INVENTION

The present invention relates to a cutting platform for the field of ceramics. In particular, the invention relates to a cutting platform for cutting and shaping a clay slab.

### DESCRIPTION OF THE RELATED ART

Typically, plain cotton cloths together with rulers, templates and various other measuring devices are used for cutting and shaping clay slabs.

Such equipment and techniques may make it time consuming to perform such tasks as cutting straight lines, parallel lines and right angles into the clay slabs. It may also be difficult to perform precision cutting and shaping of the clay slab, while maintaining the integrity of the clay slab. This may be true for ceramics professionals who deal with a high volume of clay slabs on a daily basis. This may also be true for amateur ceramic enthusiasts who may not have the same level of dexterity and skill as those who work with clay on a daily basis.

There is accordingly a need for an improved cutting platform for the field of ceramics.

### BRIEF SUMMARY OF INVENTION

The present invention provides a cutting platform disclosed herein that overcomes the above disadvantages. It is an object of the present invention to provide an improved cutting platform for cutting and shaping a clay slab.

There is accordingly provided a cutting platform for cutting and shaping a clay slab. The platform has a water-absorbing cutting mat with a top surface for receiving the clay slab. The platform has a bottom surface opposite the top surface. The bottom surface is adapted to overlay a board. The platform includes grid-pattern indicia extending across the top surface of the mat. The grid-pattern indicia includes a first set of spaced-apart lines in parallel with each other and a second set of spaced-apart lines in parallel with each other. The first set of lines intersect with and are perpendicular to the second set of apart lines. The grid-pattern indicia includes unit measurement indicia. Cutting of the clay slab to a desired shape is facilitated by the cutting platform thereby.

There is also provided a cutting platform for cutting and shaping a clay slab. The platform includes a board with a top, an underside opposite the top and a peripheral edge. The platform includes a water-absorbing cutting mat of heavy duty cotton canvas. The cutting mat has a top surface for receiving the clay slab and a bottom surface opposite the top surface. The bottom surface of the mat is adapted to overlay the board. The mat has peripheral portions folded around and which abut the underside of the board. The platform includes grid-pattern indicia extending across the top surface of the mat and upon which the clay slab overlays. The mat is positioned to extend and stretch over the top of the board such that the grid-pattern indicia at least partially extends parallel with the peripheral edge of the board. The grid-pattern indicia includes a first set of spaced-apart lines in parallel with each other and a second set of spaced-apart lines in parallel with each other. The second set of lines intersect with and are perpendicular to said first set of lines. The grid-pattern indicia includes unit measurement indicia. The unit measurement indicia includes a plurality of sets of integer indicia arranged to demark select lines of the first set of lines and arranged to demark select lines of the second set of lines. The select lines are more prominent relative to other lines of said first set of lines and said second set of lines. The integer indicia includes numeral zero demarking a point of intersection between the plurality of sets of integer indicia. Cutting of the clay slab to a desired shape is facilitated by the cutting platform thereby. The cutting platform includes a plurality of staples extending through the peripheral portions of the mat and into the board to hold the mat in place.

### BRIEF DESCRIPTION OF DRAWINGS

The invention will be more readily understood from the following description of preferred embodiments thereof given, by way of example only, with reference to the accompanying drawings, in which:

FIG. 1 is a top plan view of a cutting mat as part of a cutting platform for cutting and shaping a clay slab according to one embodiment, with grid-pattern indicia also being shown;

FIG. 2 is a cross-sectional view of the cutting platform of FIG. 1 showing the cutting mat of FIG. 1 together with a board, in this example part of a table;

FIG. 3 is a bottom perspective view of the cutting platform shown in FIG. 2, and illustrating the manner in which the cutting mat is connected to the table via staples;

FIG. 4 is a top perspective view of the cutting platform shown in FIG. 3, with the cutting mat connected to the table and the grid-pattern indicia of the mat aligning parallel with the peripheral edges of the table;

FIG. 5 is a perspective view of the cutting platform shown in FIG. 4, with a pair of spaced-apart guide sticks aligned with the grid-pattern indicia of the cutting mat, a clay slab disposed on top of the mat and between the guide sticks, and a roller, the roller shown being along the guide sticks by a person to flatten out the clay slab;

FIG. 6 is a perspective view of the cutting platform and the clay slab shown in FIG. 5, together with a clay cutting assembly therefor, the assembly including a clay cutting member and a guide, and a person's hand cutting the clay slab;

FIG. 7 is a perspective view of the cutting platform shown in FIG. 6 together with the clay slab shown in a cut form and a person's hand pulling upwards a cut strip therefrom; and

FIG. 8 is a perspective view of the guide shown of the clay cutting assembly in FIG. 6 according to another embodiment.

### DESCRIPTION OF THE PREFERRED EMBODIMENTS

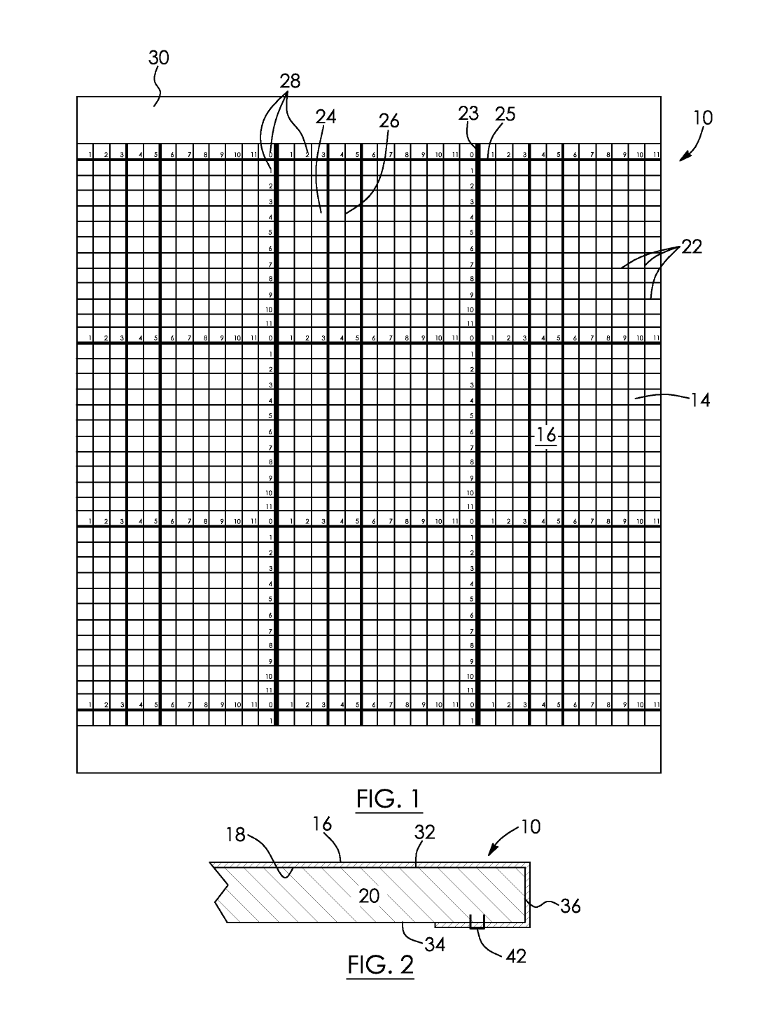

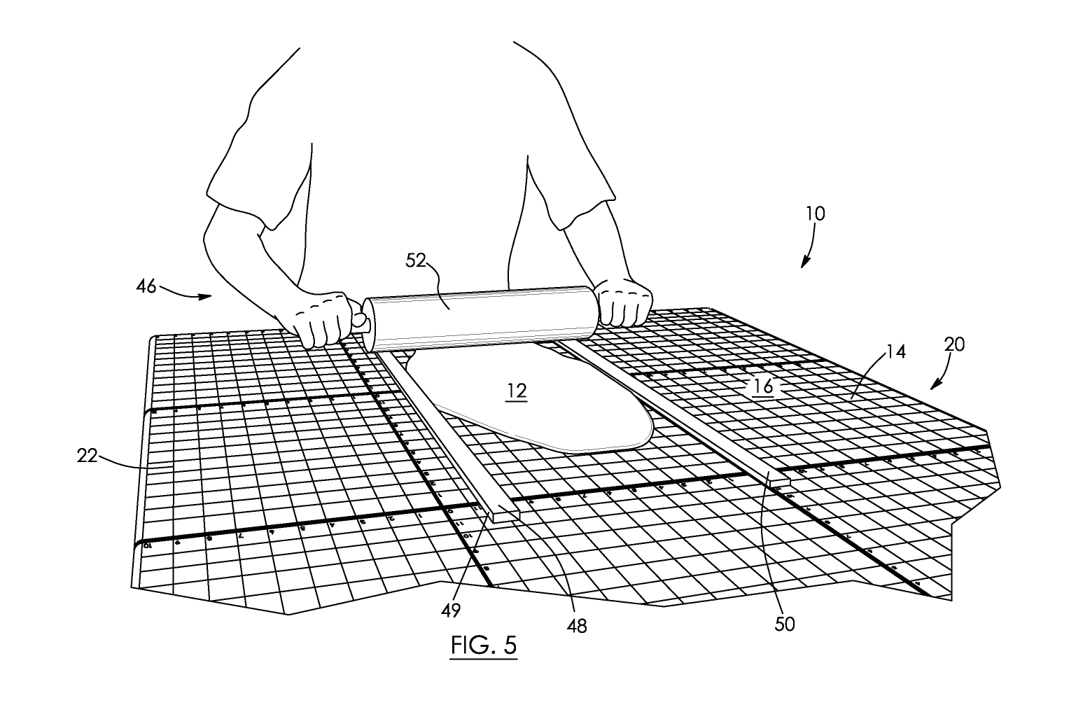

Referring to the drawings and first to FIG. 1, there is shown a cutting platform 10 for cutting and shaping a clay slab 12, shown in FIG. 5. Referring back to FIG. 1, the platform includes a water-absorbing cutting mat 14, in this example made of heavy duty cotton canvas. Because canvas is water-absorbing, the cutting platform does not stick to the clay. This is in contrast to when rolling a clay slab on the surface of a regular table-top, where the clay will oftentimes stick to said surface. The mat is generally rectangular in shape and has a top surface 16 for receiving the clay slab. Referring to FIG. 2, the mat 14 has a bottom surface 18 opposite the top surface. The bottom surface is adapted to overlay a board which in this example is rectangular and part of a table 20. The table is also a part of the cutting platform 10 in this example.

As shown in FIGS. 1 and 5, the mat 14 has a grid-pattern indicia 22 extending across its top surface 16 and upon which the clay slab overlays. The grid-pattern indicia comprises a first set of spaced-apart lines 24 in parallel with each other and a second set of spaced-apart lines 26 in parallel with each other. The first set of lines 24 intersect with and are perpendicular to the second set of lines 26.

According to one preferred embodiment, prior to the mat 14 ever contacting water, each of the lines 24 is spaced-apart by a distance of 1.05 inches with respect to adjacent ones of the lines 24. Also, each of the lines 26 is spaced-apart by a distance of 1.05 inches with respect to adjacent ones of the lines 26. Upon the mat 14 contacting water, the mat shrinks such that subsequently each of the lines 24 is spaced-apart by a distance of one inch with respect to adjacent ones of the lines 24, and each of the lines 26 is spaced-apart by a distance of one inch with respect to adjacent ones of the lines 26. Thus, in this case the sets of the lines 24 and 26 define a plurality of one inch squares. Put another way, the mat as sold has grid-pattern indicia 22 that is approximately 5% bigger relative to its size after the mat shrinks from water contact. The grid-pattern indicia 22 after shrinking therefore demarks a plurality of adjacent twelve inch by twelve inch indicia portions in this example, each of which delineates one hundred and forty-four one inch square indicia portions. Preferably, every twelfth line of the first set of lines and every twelfth line of the second set of lines is darker and thicker relative to other said lines, as shown by the intersecting lines bearing numerals 23 and 25, respectively, in FIG. 1.

The grid-pattern indicia 22 include unit measurement indicia 28 corresponding to the respective grid lines 24 and 26. In this case the measurement indicia are numbers from 0 to 11 designating one inch units as mentioned above. These repeat for each twelve inch section as shown in FIG. 1. At the point of intersection between each of the darker indicia lines 23 and 25, the measurement indicia is in the form of numeral zero. The measurement indicia 28 in themselves are arranged in intersecting columns and rows spaced-apart twelve inches.

The mat 14 has peripheral portions as shown by numeral 30.

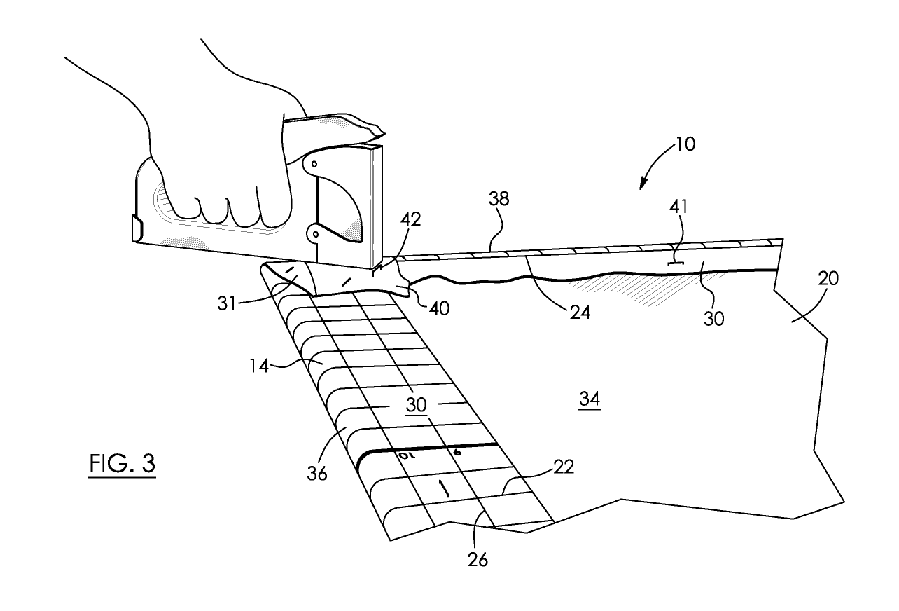

Referring to FIG. 2, the table 20 has a top 32, an underside 34 opposite the top and peripheral edges 36 and 38, shown in FIG. 3. As shown in FIGS. 2 to 4, the mat 14 is positioned to extend and stretch over the top 32 of the table. Referring to FIG. 3, the peripheral portions of the mat 14 as indicated by peripheral portion 30 fold around edges 36 and 38 of the table and abut the underside 34 of the table. The mat is positioned such that the grid-pattern indicia 22 at least partially extends parallel with the peripheral edge 36 of the table. In this case, the mat is oriented such that grid lines 26 align parallel with edge 36, and grid lines 24 align parallel with edge 38 of the table.

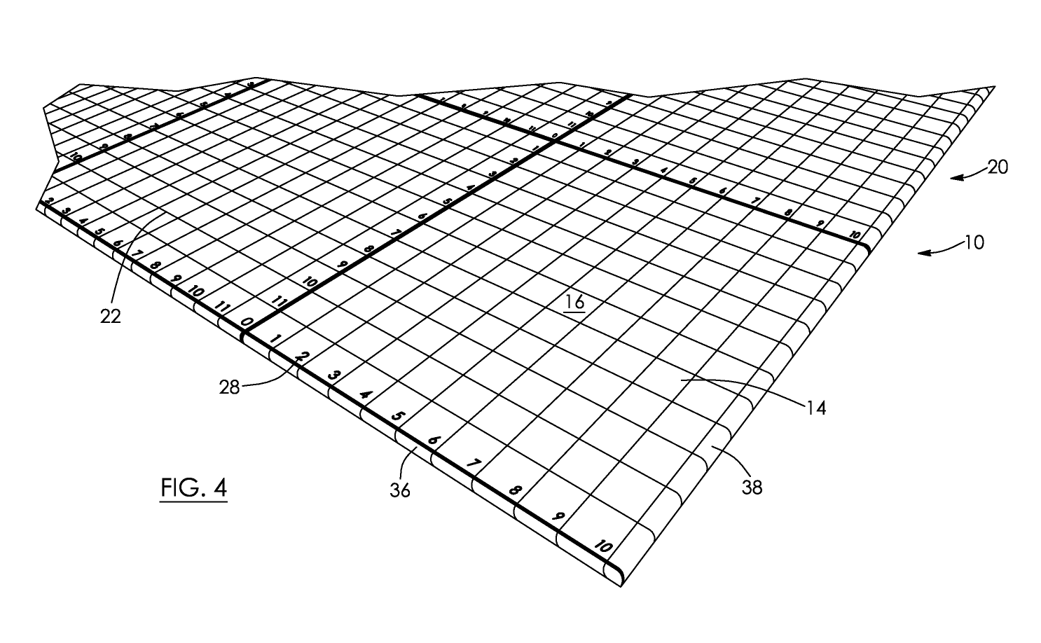

A plurality of fasteners, in this example, staples 41 may be used to extend through the peripheral portions of the mat and into the table 20 to hold the mat in place. Preferably the sides of the mat 14 should be first stretched around the table and stabled to the table so that the mat extends over the top of the table in a smooth and continuous manner. Next, the overlapping peripheral portions 31 of the mat are folded together at the corners 40 of the table. The overlapping portions 31 of the mat at the corners 40 of the table are folded into a square-shaped arrangement in this example and stapled to the table, as shown in FIG. 3 adjacent staple 42, to further secure the mat 14 in place. FIG. 4 shows the cutting platform with the mat 14 so connected to the table 20.

Referring to FIG. 5, clay slab 12 may now be placed on the cutting mat and rolled, cut and shaped as desired.

A clay cutting assembly 46 is shown in part in FIG. 5. The assembly includes a pair of spaced-apart guide sticks 48 and 50. The guide sticks are in the shape of rectangular prism in this example. Each of the guide sticks 48 and 50 has a height, as shown by numeral 49, so sized to equal to the desired thickness of the clay slab. The guide sticks 48 and 50 are spaced-apart and aligned with the mat 14 in a desired arrangement. In this example, the sticks are aligned with grid-pattern indicia 22 so as to be spaced-apart and parallel with each other. The clay slab 12 is next disposed between the sticks 48 and 50. The assembly 46 includes a roller 52 for flattening out the clay slab, which, when used in combination with guide sticks, is known per se. The roller is cylindrical in shape and is configured to abut and roll along the guide sticks and also flatten the slab until the height of the slab equals that of the sticks.

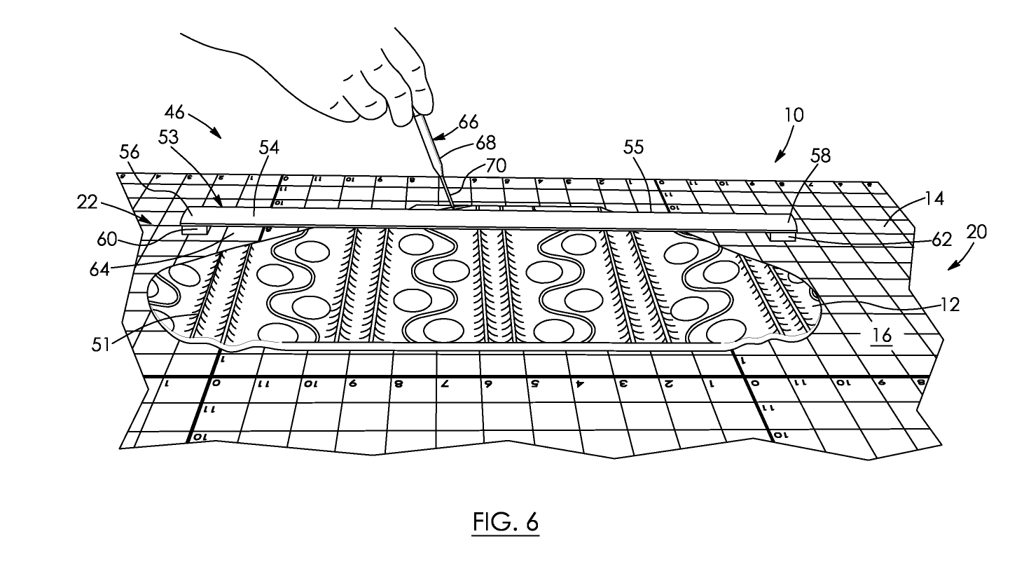

Decorative patterns may next be impressed upon the slab as indicated by numeral 51 in FIG. 6.

The clay cutting assembly 46 includes a guide 53 having an elongate portion 54 and a straight edge or surface 55 extending between ends 56 and 58 of the guide. The guide has a pair of projecting portions 60 and 62, in this example in form of cut-up erasers, extending towards the mat from said ends 56 and 58, respectively. The guide's elongate portion and projecting portions are each in the shape of a rectangular prism in this example, though this is not strictly required. Any guide having a straight-edge may be used. The projecting portions 60 and 62 form a gap 64 between the mat 14 and the guide 53 when the projecting portions abut the mat. The clay slab 12, while it is still in a partially uncut form, may extend through said gap when the guide is aligned with the grid-pattern indicia 22. The guide 53 so positioned remains spaced-apart above the slab and thus inhibits the slab from being maned when the guide is being used.

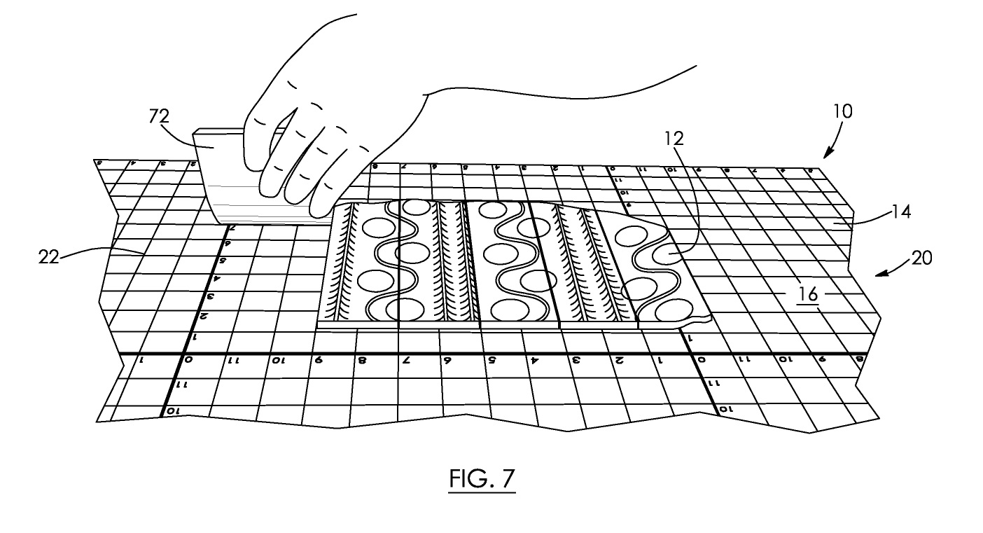

The clay cutting assembly 46 includes a clay cutting member, in this example a pottery cutting needle 66 in this example, having a handle 68 and a needle portion 70 configured to cut through the slab without cutting through the mat. The pottery cutting needle, specifically the needle portion in this example, is configured to abut and slide along the straight-edge 55 of the guide 53. The guide may thus facilitate cutting straight lines through the clay slab. FIG. 7 shows the cutting slab split into a plurality of cut strips 72 of in a desired form, size and shape.

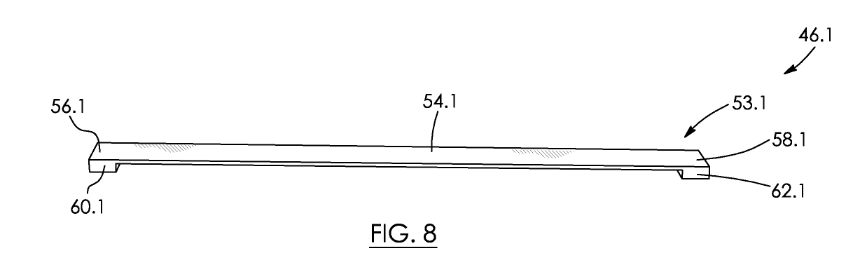

It will be appreciated that many variations are possible within the scope of the invention described herein. For example, FIG. 8 shows a guide 53.1 of a cutting assembly 46.1. Like parts of the guide and cutting assembly 46.1 shown in FIG. 8 have like numbers and function as those shown in FIG. 6 with the addition of decimal extension “0.1”. In this case, the projecting portions 60.1 and 62.1 of the guide 53.1 are integral with the rest of the guide and form a single part.

Also, the clay cutting assembly 46 may also include the cutting platform 10.

Those skilled in the art will appreciate that many variations are possible within the scope of the invention herein described. For example, in a variation, the cutting platform 10 comprises only the cutting mat 14 stapled to a piece of board, which may be disposed on top of a table. Thus, in this case, potters can use different boards (or cutting platforms) for different types of clay. For example, one board with a cutting mat attached thereto may be redware clay (red color) and another board with a cutting mat attached thereto may be for porcelain clay (white color).

The clay cutting member need not be a pottery cutting needle. For example, in a variation, the clay cutting member may be a fettling knife, which is also well known to those skilled in the art.

The invention as herein disclosed provides many advantages and may be said to represent an improved cutting platform for the field of ceramics. The cutting platform increases the ease, efficiency and precision with which clay slabs may be shaped, cut and manipulated, while at the same time reducing the number of errors that may otherwise occur using a conventional cutting platform. It may also reduce the need for templating.

It will be understood by someone skilled in the art that many of the details provided above are by way of example only and are not intended to limit the scope of the invention which is to be determined with reference to the following claims.

What is claimed is:

1. A cutting platform for cutting and shaping a clay slab, the platform comprising:
a water-absorbing cutting mat having a top surface for receiving the clay slab and a bottom surface opposite the top surface, the bottom surface being adapted to overlay a board; and
grid-pattern indicia extending across the top surface of the mat, the grid-pattern indicia including a first set of spaced-apart lines in parallel with each other, a second set of spaced-apart lines in parallel with each other, the first set of lines intersecting with and being perpendicular to said second set of apart lines, and unit measurement indicia, cutting of the clay slab to a desired shape being facilitated thereby.

2. The platform as claimed in claim 1 wherein the unit measurement indicia includes a plurality of sets of integer indicia arranged to demark select lines of the first set of lines and arranged to demark select lines of the second set of lines, said select lines being more prominent relative to other lines of said first set of lines and said second set of lines, and wherein the integer indicia includes numeral zero demarking a point of intersection between said plurality of sets of integer indicia.

3. The platform as claimed in claim 1, further including:
a table having a top and a peripheral edge, the mat being positioned to extend and stretch over the top of the table such that the grid-pattern indicia at least partially extends parallel with the peripheral edge of the table, the mat having peripheral portions folded around the peripheral edge of the table; and
a plurality of fasteners extending through the peripheral portions of the mat and into the table to hold the mat in place.

4. The platform as claimed in claim 3, wherein the table has a corner and wherein overlapping parts of the peripheral portions of the mat adjacent to the corner of the table are folded into a square-shaped arrangement and fasteners from the plurality of the fasteners extend said square-shaped arrangement for further securing the mat to the table.

5. In combination, the platform as claimed in claim 1 together with a clay cutting assembly, the assembly having:
a guide with a straight-edge, a pair of ends and a pair of projecting portions extending perpendicular from the ends, respectively, the projecting portions forming a gap between the mat and the guide when the projecting portions abut the mat and through which the clay slab may extend when the guide is aligned with the grid-pattern indicia, the guide being configured to inhibit contacting and marring of the clay slab, and
a clay cutting member, a part of which is configured to abut and slide along the straight-edge of the guide, the guide thereby facilitating cutting straight lines through the clay slab.

6. The combination as claimed in claim 5 wherein the guide has an elongate portion, the projecting portions extending from said elongate portion and wherein the elongate portion and the projecting portions are each in the shape of a rectangular prism.

7. The combination as claimed in claim 5 wherein the projecting portions of the guide are integral with the rest of the guide.

8. In combination, the platform as claimed in claim 1 together with a clay cutting assembly therefor, the assembly having
a pair of spaced-apart guide sticks each of which has a thickness, the guide sticks being spaced-apart at a distance equal to a desired width of the clay slab and being arranged to align with respective parallel, spaced-apart lines of the first set of lines, the clay slab being disposable between said guide sticks, and
a roller configured to abut, roll along and exert pressure against both of the guide sticks for holding the guide sticks in place relative to the mat and the roller being configured to roll along, flatten and stretch said clay slab disposed between the guide sticks, until the thickness of the clay slab equals that of the guide sticks.

9. The platform as claimed in claim 2 wherein the mat is configured such that, prior to the mat contacting water, each line of the first set of lines is spaced-apart by a distance of 1.05 inches with respect to an adjacent line of the first set of lines, and each line of the second set of lines is spaced-apart by a distance of 1.05 inches with respect to an adjacent line of the second set of lines, and upon the mat contacting water, the mat shrinks such that each said line of the first set of lines is spaced-apart by a distance of one inch with respect to said adjacent line of the first set of lines, and each said line of the second set of lines is spaced-apart by a distance of one inch with respect to said adjacent line of the second set of lines.

10. The platform as claimed in claim 1 wherein the grid-pattern indicia demarks a plurality of adjacent twelve inch by twelve inch indicia portions, each of which delineates one hundred and forty-four one inch square indicia portions.

11. The platform as claimed in claim 1 wherein the cutting mat is rectangular in shape and is made of heavy duty cotton canvas.

12. The platform as claimed in claim 1, wherein the board is a part of the platform.

13. A cutting platform for cutting and shaping a clay slab, the platform comprising:
a board having a top, an underside opposite the top and a peripheral edge;
a water-absorbing cutting mat of heavy duty cotton canvas, the cutting mat having a top surface for receiving the clay slab and a bottom surface opposite the top surface, the bottom surface being adapted to overlay the board, the mat having peripheral portions folded around and which abut the underside of the board;
grid-pattern indicia extending across the top surface of the mat and upon which the clay slab overlays, the mat being positioned to extend and stretch over the top of the board such that the grid-pattern indicia at least partially extends parallel with the peripheral edge of the board, the grid-pattern indicia including a first set of spaced-apart lines in parallel with each other, a second set of spaced-apart lines in parallel with each other, the second set of lines intersecting with and being perpendicular to said first set of lines, and unit measurement indicia, the unit measurement indicia including a plurality of sets of integer indicia arranged to demark select lines of the first set of lines and arranged to demark select lines of the second set of lines, said select lines being more prominent relative to other lines of said first set of lines and said second set of lines, and wherein the integer indicia includes numeral zero demarking a point of intersection between said plurality of sets of integer indicia, cutting of the clay slab to a desired shape being facilitated thereby, and
a plurality of staples extending through the peripheral portions of the mat and into the board to hold the mat in place.
